(19) United States
(12) Patent Application Publication
(10) Pub. No.: US 2012/0186096 A1
(43) Pub. Date: Jul. 26, 2012

(54) ODOR ELIMINATING PORTABLE FORCED AIR FOOTWEAR DRYING APPARATUS

(76) Inventor: George Fox, Park City, UT (US)

(21) Appl. No.: 13/012,801

(22) Filed: Jan. 25, 2011

(51) Int. Cl. F26B 25/00

(52) U.S. Cl. 34/104

(57) ABSTRACT

A portable, forced air footwear drying apparatus is disclosed, adapted to simultaneously dry a plurality of footwear, such as ski boots, with forced ambient air using one or more flexible tubes, a fan, and cedar insert.

### BACKGROUND OF THE INVENTION

1. Field of the Invention

This invention relates to footwear, and more particularly relates to devices for drying wet footwear using ambient air.

2. Description of the Related Art

Unsophisticated footwear drying apparatii are known in the art. Most comprise a single under-powered fan enclosed in irregularly shaped housing and are capable of drying only one piece of footwear at a time. Footwear drying apparatii known in the art make use of heating elements to heat air and more quickly dry subject footwear, but in the process damage the footwear by exposing the footwear to temperatures in excess of those the footwear was designed to withstand.

Because traditional drying appartti can dry only one piece of footwear at time, ski equipment rental business enterprises can experience extended lag times between equipment return and equipment re-lease. Bacteria, filth mold and consequential odor develop in footwear waiting to be dried which can be difficult to eliminate.

Current drying devices known in the art provide no means of eliminating odor, fragranting insoles, nor of preventing damage to footwear caused by excessive temperatures in the drying process. Current devices cannot be feasibly used to quickly dry a plurality of footwear devices, and many are not portable.

It is therefore desirable that a portable, durable, forced air footwear dryer be provided.

### SUMMARY OF THE INVENTION

From the foregoing discussion, it should be apparent that a need exists for portable, odor eliminating forced air footwear drying apparatus. Beneficially, such a drying apparatus would overcome many of the difficulties with prior art by providing a means for drying without use of increased temperatures.

The present invention has been developed in response to the present state of the art, and in particular, in response to the problems and needs in the art that have not yet been fully solved by currently available information management systems. Accordingly, the present invention has been developed to provide a portable footwear drying apparatus comprising: a housing defining a hollow recess of between 0.1 liters and 4 liters in volume, the housing enclosing a mechanical fan, the housing comprising one or more apertures for intaking ambient air, the housing comprising a plurality of apertures for gripping detachable tubes.

The portable footwear drying apparatus also comprises a plurality of elongated, cylindrical, flexible, detachable tubes, the tubes detachably affixed to the housing at the apertures, the tubes each comprising a hollow body having an proximal end, a proximal opening for received pressurized air, a distal end and a distal opening for releasing pressurized air, the tubes between 6 centimeters and 6 meters in length; and one or more cedar wood insert(s) affixed to the housing for adding fragrance to ambient air exiting the mechanical fan.

In various alternative embodiments of the present invention, the portable footwear drying device comprises an axial-flow fan, a crossflow fan, or a centrifugal fan.

The portable footwear drying device may further comprise a compressor affixed to the inside of the housing within the hollow recess and/or a heating element enclosed within the housing between the fan and the plurality of tubes.

The portable footwear drying device may further comprise a heating element enclosed within the housing between the fan and the plurality of tubes.

The tubes may be extrudable, and the housing may be geometrically cubic in shape.

The fan may be powered by 12 volt direct current (D/C), and the drying device further comprising a male plug for use in an automotive cigarette lighter receptacle.

The portable footwear drying device may further comprising a grill covering one or more of the apertures for intaking ambient air, the grill for filtering objects out of ambient air entering the housing, and may further comprise a plurality of mechanical fans.

The cedar wood insert may be detachable. The portable footwear drying device may further comprise a 120 volt A/C power supply and/or a strap affixed the housing for portability and/or a tripod for stabilizing the footwear drying device above one or more shoes.

One side of the cedar insert may be covered by a diamond plate. The majority of the housing by weight may fabricated from exscinded vinyl fencing.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side elevational perspective environmental view of a portable footwear drying device in accordance with the present invention;

FIG. 2 is a top plan view of a portable footwear drying device in accordance with the present invention;

FIG. 3 is a lower elevational view of a portable footwear drying device in accordance with the present invention; and

FIG. 4 is a lower elevational view of a portable footwear drying device in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

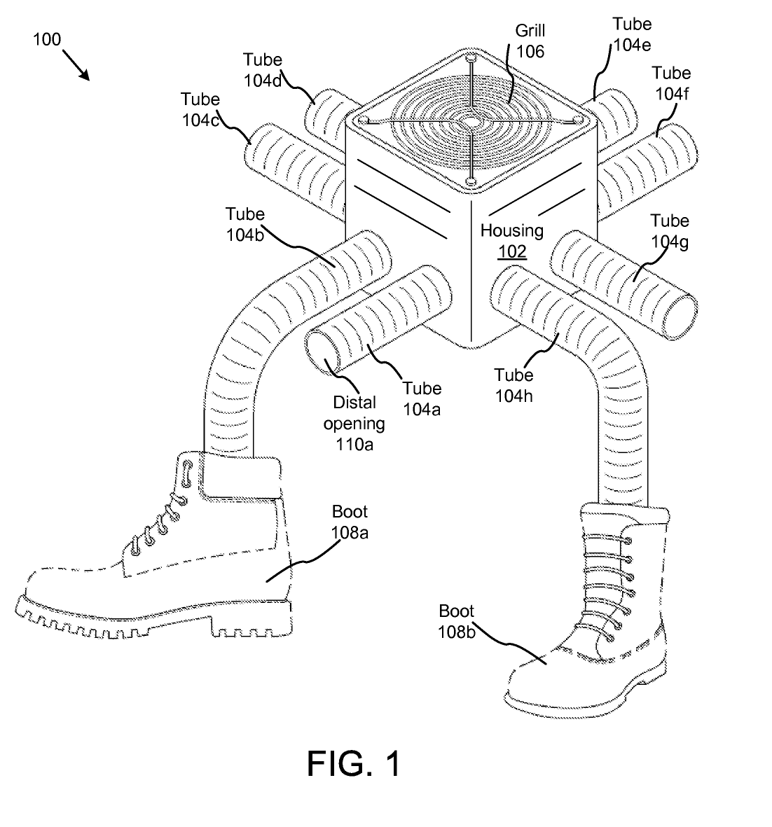

FIG. 1 is a side elevational perspective environmental view of a portable footwear drying device 100 in accordance with the present invention. The footwear drying device 100 comprises a housing 102, a tube 104a, a tube 104b, a tube 104c, a tube 104c, a tube 104d, a tube 104e, a tube 104f, a tube 104g, a tube 104h, and a grill 106. Tube 104a comprises a distal opening 110a. Also shown are a shoe 108a and a shoe 108b.

The housing 102, in the shown embodiment, comprises a cubic-shaped polymer housing with a number of holes, bores, or apertures. At least one aperture serves as an air intake for a mechanical fan enclosed within the housing 102. This aperture, in the shown embodiment, is covered by the grill 106. At least one aperture is circular in shape and serves the purpose of receiving a detachable tube 104, such as tubes 104a-h.

The housing 102 may be manufactured from polymers, wood (including cedar wood), metals, alloys, and the like. The housing 102 may also consist of a frame or chassis. The housing 102 in the shown the embodiment is cubic in shape. In alternative embodiments, the housing 102 may be spherical in shape, conical, hemispherical, polygonal, or otherwise.

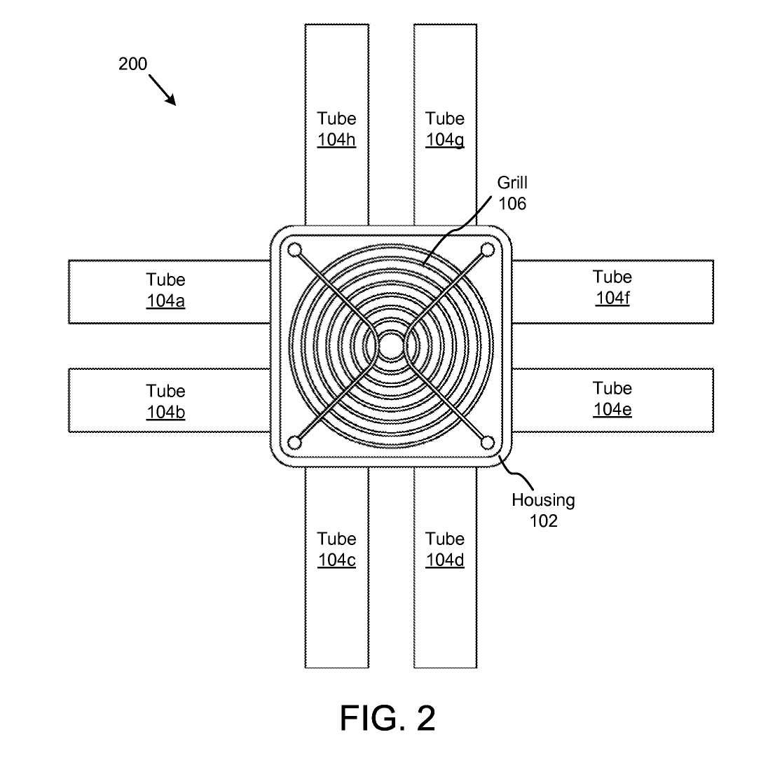

The housing 102 may also comprise, or define, one or more aperture(s) for housing a piece of cedar wood as further explained below in relation to FIGS. 2-4.

The housing 102 comprises a plurality of apertures for receiving the proximal ends of the tubes 104a-h. The apertures comprise holes or recesses in the housing 102 which allow air to flow from within the housing 102 through the apertures.

The housing 102 defines a hollow cavity within it, exposed to ambient air through the apertures. The volume of the hollow cavity varies across different embodiments from 0.1 liters to 10 liters.

The footwear dryer 100 also comprises the tubes 104a-h. The tubes, in the shown embodiment, are extrudable and/or telescopic.

The tubes 104a-h comprise a plurality of elongated, cylindrical, flexible, detachable tubes, the tubes detachably affixed to the housing at the apertures, the tubes each comprising a hollow body having an proximal end, a proximal opening for received pressurized air, a distal end and a distal opening for releasing pressurized air, the tubes between 6 centimeters and 6 meters in length.

The tubes' 104a-h proximal ends are detachable affixable to the housing 102. The tubes' 104a-h distal ends are in insertable into footwear 108a-h as shown. Pressurized ambient air is forced through the apertures into the proximal ends of the tubes 104a-h by the fan. The pressurized air then exits through the distal opening 110 into a shoe 108. In other embodiments, the fan is reversed and ambient air is pulled by the fan from the shoes 108a-b.

The tubes 104a-h may comprise heating elements for hearing air traveling through the tubes 104a-h.

The fan may comprise any fan well-known to those of skill in the art, including centrifugal, crossflow and axial flow. In various embodiments of the present invention, the fan is replaced by a compressor. In various embodiments of the present invention, the footwear dryer 100 comprises a plurality of fans and/or compressors.

The tubes may comprise polymers, metals, alloys, surgical tubing, garden hosing, flexible piping, or any other type of tubing known to those of skill in the art.

In alternative embodiments of the present invention, the mechanical fan may be reversed to pull air from the shoes 108a-b, thus drying the shoes with ambient air entering the shoes and being pulled from within by the footwear dryer 100.

In various embodiments of the present invention, the housing 102 is detachably affixed to a tripod for stabilizing the footwear dryer 100 above the shoes 108a-b. Tripods are well-known to those of skill in the art.

FIG. 2 is a top plan view of a portable footwear drying device in accordance with the present invention. The footwear drying device 200 comprises a housing 102, a tube 104a, a tube 104b, a tube 104c, a tube 104c, a tube 104d, a tube 104e, a tube 104f, a tube 104g, a tube 104h, and a grill 106.

The housing 102, tubes 104a-h, and grill are substantially described above in relation to FIG. 1.

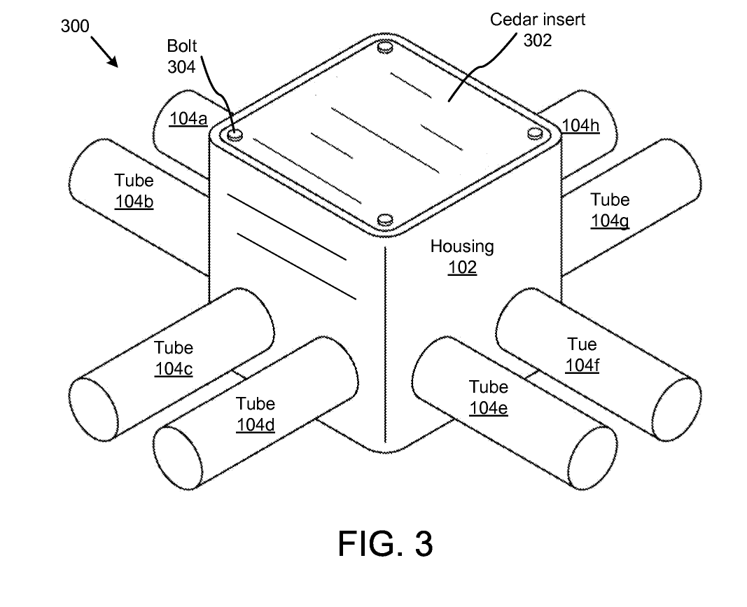

FIG. 3 is a lower elevational view of a portable footwear drying device in accordance with the present invention. The footwear drying device 300 comprises a housing 102, a tube 104a, a tube 104b, a tube 104c, a tube 104c, a tube 104d, a tube 104e, a tube 104f, a tube 104g, a tube 104h, a cedar insert 302, and a bolt 304.

The housing 102 is substantially described above in relation to FIGS. 1-2.

The cedar insert 302 comprises a substantially planar board of cedar wood. In various embodiments, the cedar insert 302 fills a recess defined by the housing 102. In other embodiments, the cedar insert 302 is enclosed within the housing 102. In the preferred embodiment the cedar insert 302 is in contact with pressurized ambient air forced through the fan.

Cedar wood is known to have odor eliminating properties, as well as fragrant properties useful in masking the scent of bacteria, mold and dirt in the shoes 108a-b. Ambient air forced into contact with the cedar insert 302 adsorbs and transmits these odor eliminating and fragrant properties into the shoes 108a-b.

The cedar insert 302 may be from 1 millimeter to 10 centimeters thick, and from 0.5 square millimeters to 100 square centimeters across the surface of the cedar insert 302 in contact with the pressurized ambient air.

In various embodiments, the cedar insert 302 is bolted on to the housing 102 using bolts 304. In other embodiments, the cedar insert 302 is affixed to the housing nails, screws, clasps, buckles and/or adhesives commonly known to those of skill in the art. In various embodiments of the present invention, the cedar insert 302 is detachably affixed to, or within, the housing 102.

In some embodiments of the present invention, the cedar insert 302 is covered its face which faces outward, or away, from the housing 102 by a metal diamond plate, such a highly polished aluminum diamond plate by Diamond Plate™ or by other manufacturers well known to those of skill in the art.

In various embodiments, the drying device 300 is power by a 120 volt external power supply, or by an automobile detachably connected to the drying device 300 vis-à-vis a cigarette lighter receptacle (or socket).

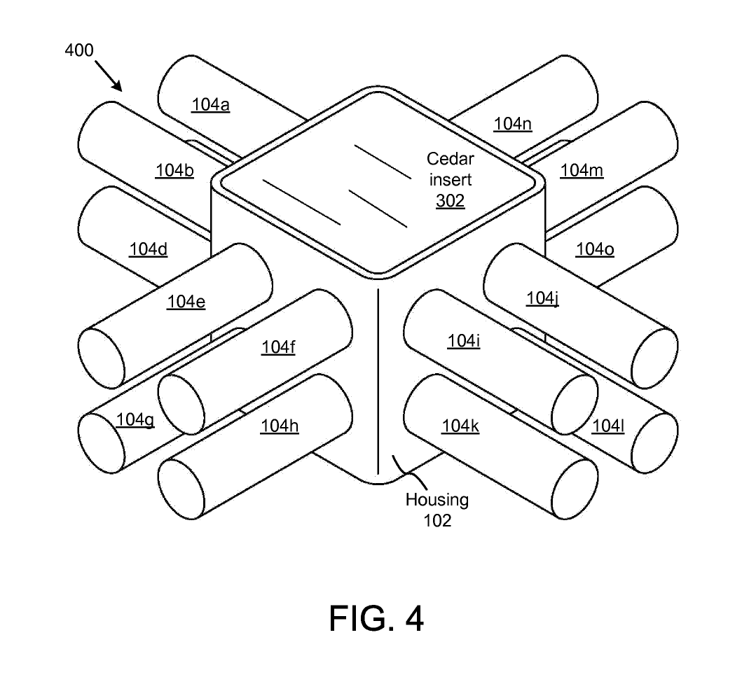

FIG. 4 is a lower elevational view of a portable footwear drying device 400 in accordance with the present invention. The footwear drying device 400 comprises a housing 102, a tube 104a, a tube 104b, a tube 104c, a tube 104c, a tube 104d, a tube 104e, a tube 104f, a tube 104g, a tube 104h, a tube 104i, a tube 104j, a tube 104k, a tube 104l, a tube 104m, a tube 104n, a tube 104o, a tube 104p, and a cedar insert 302.

The housing 102 and cedar insert 302 are substantially described above in relation to FIGS. 1-3.

The tubes 104a-p are also substantially described above in relation to FIGS. 1-3, but shown in larger numbers in FIG. 4. In various embodiments of the present invention, the footwear dryer 400 may comprise between one and one hundred tubes 104 protruding from the housing 102. The apertures in the housing 102, into which the tubes 104a-p are detachably affixed, may be arranged around the lateral sides of the housing 102 in repeating patterns as shown, or may be irregularly arranged around the outside of the housing 102.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A portable footwear drying device comprising:
a housing defining a hollow recess of between 0.1 liters and 4 liters in volume, the housing enclosing a mechanical fan, the housing comprising one or more apertures for intaking ambient air, the housing comprising a plurality of apertures for gripping detachable tubes;
a plurality of elongated, cylindrical, flexible, detachable tubes, the tubes detachably affixed to the housing at the apertures, the tubes each comprising a hollow body having an proximal end, a proximal opening for received pressurized air, a distal end and a distal opening for releasing pressurized air, the tubes between 6 centimeters and 6 meters in length; and
one or more cedar wood insert(s) affixed to the housing for adding fragrance to ambient air exiting the mechanical fan.

2. The portable footwear drying device of claim 1, wherein the fan comprises an axial-flow fan.

3. The portable footwear drying device of claim 1, wherein the fan comprises a crossflow fan.

4. The portable footwear drying device of claim 1, wherein the fan comprises a centrifugal fan.

5. The portable footwear drying device of claim 1, further comprising a compressor affixed to the inside of the housing within the hollow recess.

6. The portable footwear drying device of claim 1, further comprising a heating element enclosed within the housing between the fan and the plurality of tubes.

7. The portable footwear drying device of claim 1, further comprising a heating element enclosed within one or more of the plurality of tubes.

8. The portable footwear drying device of claim 1, wherein the tubes are extrudable.

9. The portable footwear drying device of claim 1, wherein the housing is geometrically cubic in shape.

10. The portable footwear drying device of claim 1, further comprising a grill covering one or more of the apertures for intaking ambient air, the grill for filtering objects out of ambient air entering the housing.

11. The portable footwear drying device of claim 1, further comprising a plurality of mechanical fans.

12. The portable footwear drying device of claim 1, wherein the cedar wood insert is detachable.

13. The portable footwear drying device of claim 1, further comprising an aluminum diamond plate covering an outside edge of the cedar insert.

14. The portable footwear drying device of claim 1, further comprising a 120 volt A/C power supply.

15. The portable footwear drying device of claim 1, wherein the fan is powered by 12 volt direct current (D/C), the drying device further comprising a male plug for use in an automotive cigarette lighter receptacle.

16. The portable footwear drying device of claim 1, further comprising a strap affixed the housing for portability.

17. The portable footwear drying device of claim 1, further comprising a chain affixed the housing for portability.

18. The portable footwear drying device of claim 1, further comprising a tripod for stabilizing the footwear drying device above one or more shoes.

19. The portable footwear drying device of claim 1, wherein the majority of the housing by weight is fabricated from exscinded vinyl fencing.
